(19) United States
(12) Patent Application Publication
(10) Pub. No.: US 2025/0202383 A1
(43) Pub. Date: Jun. 19, 2025

(54) H-BRIDGE TYPE PARALLEL MULTI-LEVEL INVERTER SWITCH MODULE, METHOD FOR OPTIMIZING THE SAME AND INVERTER USING THE SAME

(71) Applicants: HARBIN INSTITUTE OF TECHNOLOGY (WEIHAI), Weihai City (CN); WEIHAI TIANDA AUTOMOBILE TECHNOLOGY CO.,LTD, Weihai City (CN)

(72) Inventors: Dafang WANG, Weihai City (CN); Qi LI, Weihai City (CN); Jianqi HUANG, Weihai City (CN); Dekuan KONG, Weihai City (CN); Pengbin XU, Weihai City (CN); Zhenjiang GAO, Weihai City (CN); Yi JIN, Weihai City (CN); Yonglun JIANG, Weihai City (CN); Yingkang QIN, Weihai City (CN); Haonan SUN, Weihai City (CN); Yujin ZHANG, Weihai City (CN)

(73) Assignees: HARBIN INSTITUTE OF TECHNOLOGY (WEIHAI), Weihai City (CN); WEIHAI TIANDA AUTOMOBILE TECHNOLOGY CO.,LTD, Weihai City (CN)

(21) Appl. No.: 18/804,319

(22) Filed: Aug. 14, 2024

(30) Foreign Application Priority Data
Dec. 13, 2023 (CN) 202311722794.8

(51) Int. Cl. H02M 7/5387; H02M 1/00

(52) U.S. Cl. CPC H02M 7/53871; H02M 1/0058

(57) ABSTRACT

An H-bridge type parallel multi-level inverter switch module, a method for optimizing the same, and an inverter using the same are provided. The switch module includes two switching units and an H-bridge inductor; each switching unit includes a first power device and a second power device connected in series, where the source of the first power device is connected to the drain of the second power device and this connection is used as the neutral point of the switching unit; the drains of the first power devices of the two switching units are connected to each other, and the sources of the second power devices of the two switching units are connected to each other; two ends of the H-bridge inductor are connected to the neutral points of the two switching units respectively.

### CROSS REFERENCE TO RELATED APPLICATION

This application claims the benefit of and priority from Chinese Patent Application No. 202311722794.8, filed Dec. 13, 2023, the entire disclosure of which is incorporated herein by reference.

### TECHNICAL FIELD

The present application relates to the technical field of inverters, refers to the control technique of parallel multi-level inverters, and more specifically, to an H-bridge type parallel multi-level inverter switch module, a method for optimizing the H-bridge type parallel multi-level inverter switch module, and an inverter using the H-bridge type parallel multi-level inverter switch.

### BACKGROUND

As a key component of the motor drive system of new energy vehicles, the inverter has become one of the important factors promoting the development of new energy vehicles. At the same time, with the rise of the third generation of wide bandgap semiconductor materials, silicon carbide based power devices (SiC MOSFET) have gradually replaced silicon based power devices (Si IGBT) and become the mainstream semiconductor power device constituting inverters on the market.

The inverter parallel multi-level topology formed by connecting multiple SiC MOSFETs in parallel can meet the working conditions of high current, high power, and high switching speed.

### SUMMARY

The first aspect of the present application provides an H-bridge type parallel multi-level inverter switch module, which includes two switching units and an H-bridge inductor.

Each of the two switching units includes a first power device and a second power device connected in series, wherein a source of the first power device is connected to a drain of the second power device, and a connection is used as a neutral point of the switching unit.

The drains of the first power devices of the two switching units are connected to each other, and the sources of the second power devices of the two switching units are connected to each other.

Two ends of the H-bridge inductor are respectively connected to the neutral points of the two switching units.

In some embodiments, the first power device and the second power device are both high-level turn-on silicon carbide based power devices.

In some embodiments, the first power device and the second power device have the same specification, an inductance value of the H-bridge inductor satisfies the following formula:

$$8 L \cdot {C}_{o s s} = ( 2 {T}_{s} - {T}_{d} + 3 {R}_{g} \cdot {C}_{iss} \cdot ln \frac{{V}_{g s}}{{V}_{t h}} + {R}_{g} \cdot {C}_{i s s} \cdot ln \frac{{V}_{g s}}{{V}_{g s} - {V}_{t h}} ) \times ( {T}_{d} + {R}_{g} \cdot {C}_{i s s} \cdot ln \frac{{V}_{t h}}{{V}_{g s} - {V}_{t h}} ) ,$$

where T_{g} and T_{d} are the phase shift time and the dead time of each power device respectively, V_{gs} and Vₜₕ are the gate-source voltage and the threshold voltage of each power device respectively, R_{g}, Cᵢₛₛ, and Cₒₛₛ are the gate drive resistance, the input capacitance, and the output capacitance of each power device respectively.

The second aspect of this application provides a method for optimizing an H-bridge type parallel multi-level inverter switch module, for optimizing the above-mentioned H-bridge type parallel multi-level inverter switch module, including the following steps 1-2.

Step 1: obtaining switching loss of the H-bridge type parallel multi-level inverter switching module in a complete switching cycle;

Step 2: optimizing the switching loss of the H-bridge type parallel multi-level inverter switch module in the complete switching cycle based on a zero-voltage switching strategy under a light load operating condition, and determining an optimum inductance value for an H-bridge inductor.

In some embodiments, the switching loss of the H-bridge type parallel multi-level inverter switch module in the complete switching cycle includes reverse switching loss of the first power device of each switching unit and forward switching losses of the second power device of each switching unit.

In some embodiments, optimizing the switching loss of the H-bridge type parallel multi-level inverter switch module in the complete switching cycle based on a zero-voltage switching strategy under a light load operating condition includes: when an inverter circuit reaches a steady state under the light load operating condition, letting the H-bridge type parallel multi-level inverter switch module satisfy the first, second, and third constraints.

In some embodiments, the first constraint is that an inductor current at the beginning of the complete switching cycle is equal to an inductor current at the end of the complete switching cycle;

In some embodiments, the second constraint is that a voltage across the H-bridge inductor changes symmetrically within the complete switching cycle.

In some embodiments, the third constraint is that the reverse switching loss of the first power device of each switching unit is minimal within the complete switching cycle.

In some embodiments, when an output current is less than or equal to 10% of a rated operating point current, the inverter circuit is in the light load operating condition.

In some embodiments, each of the first power device and the second power device includes a high-level turn-on channel, a Schottky diode, and has a parasitic output capacitor.

In some embodiments, the H-bridge type parallel multi-level inverter switch module includes four charging and discharging intervals in the complete switching cycle, and in each of the charging and discharging intervals, the H-bridge inductor is used to charge and discharge the parasitic output capacitors of two power devices of one switching unit respectively.

The third constraint is that in each charging and discharging interval, the H-bridge inductor completely charges and discharges the parasitic output capacitors of the two power devices of one switching unit respectively.

The third aspect of the present application provides an inverter using the above-mentioned H-bridge type parallel multi-level inverter switch module for converting a current output by a DC power supply into an input current of a multi-phase motor, where an output current of each phase is generated by at least one H-bridge type parallel multi-level inverter switch module and a corresponding cascaded coupling induction network.

### BRIEF DESCRIPTION OF DRAWINGS

FIG. 1 shows the topology of a parallel multi-level inverter;

FIG. 2 is a schematic diagram of an analysis model of a double-pulse switching circuit;

FIG. 3A is a gate signal timing diagram of power devices S₁ and S₂ in a complete switching cycle;

FIG. 3B shows a direction situation of the current flow of a power device S₂ during the turn-on process;

FIG. 3C shows a direction situation of the current flow of a power device S₂ during the turn-off process;

FIG. 4A shows changes in the voltage and the current of a switching branch in switching process 1 when the parallel multi-level inverter shown in FIG. 1 is under heavy load operating conditions;

FIG. 4B shows changes in the voltage and the current of a switching branch in switching process 2 when the parallel multi-level inverter shown in FIG. 1 is under heavy load operating conditions;

FIG. 5A shows a first direction situation of the current flow of a switching branch in switching process 1 when the parallel multi-level inverter shown in FIG. 1 is under heavy load operating conditions;

FIG. 5B shows a second direction situation of the current flow of a switching branch in switching process 1 when the parallel multi-level inverter shown in FIG. 1 is under heavy load operating conditions;

FIG. 5C shows a third direction situation of the current flow of a switching branch in switching process 1 when the parallel multi-level inverter shown in FIG. 1 is under heavy load operating condition;

FIG. 5D shows a fourth direction situation of the current flow of a switching branch in switching process 1 when the parallel multi-level inverter shown in FIG. 1 is under heavy load operating conditions;

FIG. 5E shows a fifth direction situation of the current flow of a switching branch in switching process 1 when the parallel multi-level inverter shown in FIG. 1 is under heavy load operating conditions;

FIG. 6 shows changes in the voltage and the current of a switching branch in switching process 2 when the parallel multi-level inverter shown in FIG. 1 is under light load operating conditions;

FIG. 7A shows a direction situation of the current flow of a switching branch at time t₃-t₄ of switching process 2 when the parallel multi-level inverter shown in FIG. 1 is under light load operating conditions;

FIG. 7B shows a direction situation of the current flow of a switching branch at time t₄-t₅ of switching process 2 when the parallel multi-level inverter shown in FIG. 1 is under light load operating conditions;

FIG. 8 is a schematic diagram of the topology of an inverter using an H-bridge type parallel multi-level inverter switch module according to embodiments of the present application;

FIG. 9 shows the gate signal, and changes of the voltage and the current in a complete switching cycle of an H-bridge type parallel multi-level inverter switch module provided according to embodiments of the present application;

FIG. 10A shows the direction situation of the current flow of an H-bridge type parallel multi-level inverter switch module at interval I according to embodiments of the present application;

FIG. 10B shows a direction situation of the current flow of an H-bridge type parallel multi-level inverter switch module at interval II according to embodiments of the present application;

FIG. 10C shows a direction situation of the current flow of the H-bridge type parallel multi-level inverter switch module at interval III according to embodiments of the present application;

FIG. 10D shows a direction situation of the current flow of an H-bridge type parallel multi-level inverter switch module at interval IV according to embodiments of the present application;

FIG. 10E shows a direction situation of the current flow of an H-bridge type parallel multi-level inverter switch module at interval V according to embodiments of the present application;

FIG. 10F shows a direction situation of the current flow of an H-bridge type parallel multi-level inverter switch module at interval VI according to embodiments of the present application;

FIG. 10G shows a direction situation of the current flow of an H-bridge type parallel multi-level inverter switch module at interval VII according to embodiments of the present application;

FIG. 10H shows a direction situation of the current flow of an H-bridge type parallel multi-level inverter switch module at interval VIII according to embodiments of the present application;

FIG. 11 is a flow chart of a method of optimizing an H-bridge type parallel multi-level inverter switch module according to embodiments of the present application;

FIG. 12 shows the gate signal and changes of the voltage and the current of an H-bridge type parallel multi-level inverter switch module at interval II according to embodiments of the present application;

FIG. 13A shows a direction situation of the current flow of an H-bridge type parallel multi-level inverter switch module in stage I of interval II according to embodiments of the present application;

FIG. 13B shows a direction situation of the current flow of an H-bridge type parallel multi-level inverter switch module in stage II of interval II according to embodiments of the present application;

FIG. 13C shows a direction situation of the current flow of an H-bridge type parallel multi-level inverter switch module in stage III of interval II according to embodiments of the present application;

FIG. 13D shows a direction situation of the current flow of an H-bridge type parallel multi-level inverter switch module in stage IV of interval II according to embodiments of the present application;

FIG. 13E shows a direction situation of the current flow of an H-bridge type parallel multi-level inverter switch module in stage V of interval II according to embodiments of the present application;

FIG. 13F shows a direction situation of the current flow of an H-bridge type parallel multi-level inverter switch module in stage VI of interval II according to embodiments of the present application;

FIG. 14 shows waveforms of the driving signal, the drain-source voltage, and the voltage and the current of an H-bridge inductor of a power device in some embodiments;

FIG. 15A is a waveform diagram of the voltage and the current of a power device Sₕ₁ in some embodiments;

FIG. 15B is a waveform diagram of the voltage and the current of a power device Su in some embodiments;

FIG. 15C is a waveform diagram of the voltage and the current of a power device Sₕ₂ in some embodiments;

FIG. 15D is a waveform diagram of the voltage and the current of a power device Sₗ₂ in some embodiments;

FIG. 16 shows a waveform diagram of the voltage and the current of a bridge arm on a right branch in some embodiments; and

FIG. 17 is a chart of the comparison between the system loss of zero-voltage turn-on realized by adding an H-bridge inductor and the system loss of hard switching without adding an H-bridge inductor.

### DESCRIPTION OF EMBODIMENTS

Hereinafter, the present application will be further described based on exemplary embodiments and with reference to the accompanying drawings.

In the description of the embodiments of the present application, it should be noted that the terms “upper”, “lower”, “inner”, “outer”, etc. are used to indicate the orientational or positional relationship indicated based on the orientation or position shown in the drawings or the orientational or positional relationship in which the products of the embodiments of the present application are commonly placed when used. They are only used for the convenience of describing the present application and simplifying the description, but not intended to indicate or imply that the apparatus or power device referred to must have a specific orientation, be constructed and operated in a specific orientation, and therefore should not be construed as limiting this application. In addition, in the description of this application, in order to distinguish different units, terms such as first and second are used in this specification, but these will not be limited by the order of manufacture, nor can they be understood to indicate or imply relative importance. These terms may be different in the detailed description and claims of this application.

The vocabulary in this specification is used to describe the embodiments of the present application, but is not intended to limit the present application. It should also be noted that unless otherwise clearly stated and limited, the terms “set”, “connected” and “connection” should be understood in a broad sense. For example, it can be a fixed connection, a detachable connection, or an integrated connection; a mechanical connection, a direct connection, an indirect connection through an intermediate medium; or an internal connection between two power devices. Those skilled in the art can In some embodiments understand the specific meanings of the above terms in the present application.

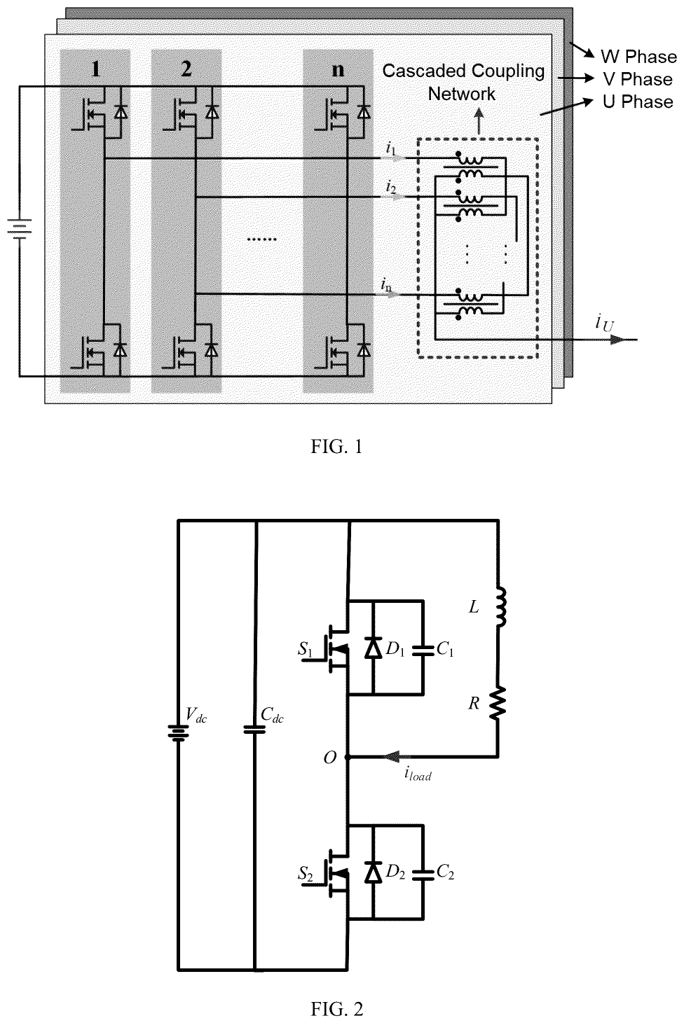

FIG. 1 is a topological structure of an inverter using a parallel multi-level architecture. The topological structure at the top of the figure is the U-phase control part of the inverter. As shown in FIG. 1, the U-phase control part of the inverter includes n parallel switching branches (parallel switching branch1, parallel switching branch 2, . . . , parallel switching branch n), and a cascaded coupling network.

In FIG. 1, each parallel switching branch is formed by two high-level turn-on power devices connected in series, where each power device is a SiC MOSFET (i.e., a silicon carbide based metal oxide semiconductor field effect transistor). The two power devices have the same orientation. The drain of the power device S₁ located above and the source of the power device S₂ located below are respectively connected to the positive pole and the negative pole of a DC power supply. The source of the power device S₁ located above is connected to the drain of the power device S₂ located below and used as a neutral point to lead out the parallel switching branch current (recorded as branch current i₁, branch current i₂, . . . , branch current in respectively). The gates of the two power devices S₁ and S₂ included in each parallel switching branch are used to receive control signals to control the led-out branch currents i₁˜iₙ. Each parallel switching branch current, after passing through the cascaded coupling network, finally generates the U-phase input current i_{U} of a motor. The topology structure and working principle of the control parts of the V-phase and the W-phase are the same as those of the U-phase.

The inverter parallel topology formed by connecting the above-mentioned power devices constructed of multiple SiC MOSFETs in parallel may meet the working conditions of high current, high power, and high switching speed. However, the large number of power devices in the parallel topology will bring greater losses, thereby generating a large amount of heat and causing damage to the power devices. Furthermore, through actual measurement of the switching losses of each parallel switching branch during the entire switching cycle using a simulation machine, it was found that the switching loss of the parallel switching branch composed of two silicon carbide based power devices S₁ and S₂ connected in series changes significantly depending on the load conditions. Especially under light load operating conditions or even a no-load operating condition, the switching loss of each parallel switching branch increases significantly, resulting in a phenomenon where the load current is small but the system loss is large.

This application uses the H-bridge type parallel multi-level inverter switch module and the inverter using the module provided in the embodiments described below to solve the problem that the switching loss of each parallel switching branch under the above light load operating conditions increases significantly. In order to clearly explain the improvements of the technical solution of the present application compared to the conventional technique, the mechanism behind the above problems will be described in detail first.

### [Switching Losses of Parallel Multi-Level Inverters Under Various Operating Conditions]

The analysis of switching losses of parallel multi-level inverters can be achieved by analyzing one of the parallel switching branches. To this end, a double-pulse switching circuit analysis model as shown in FIG. 2 can be built. In FIG. 2, the power device S₁ and S₂ are respectively shown as their equivalent models. As shown in FIG. 2, from left to right, the power device S₁ includes a high-level turn-on channel, a Schottky diode D₁, and a parasitic output capacitor C₁. Similarly, from left to right, the power device S₂ includes a high-level turn-on channel, a Schottky diode D₂, and a parasitic output capacitor C₂. V_{dc} is a bus voltage, and C_{dc} is a bus capacitor, R and L are inductive loads in the double-pulse circuit. In some embodiments, the two power devices in a parallel switching branch can use the same specifications. Therefore, the parameter values of S₁ and S₂ are the same.

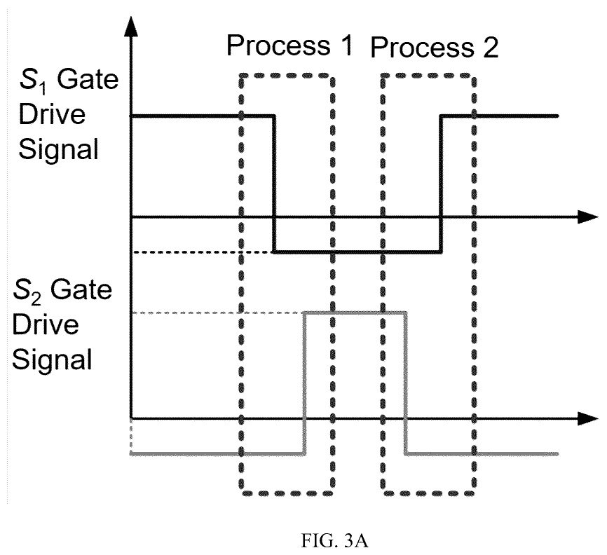

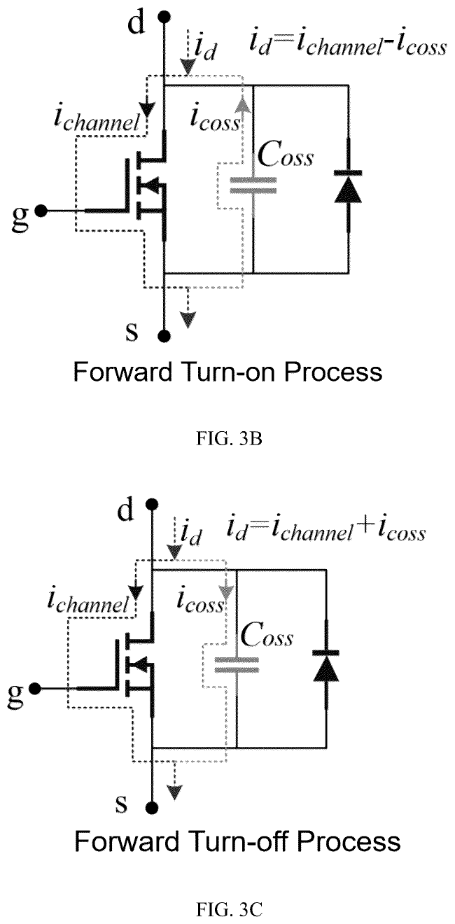

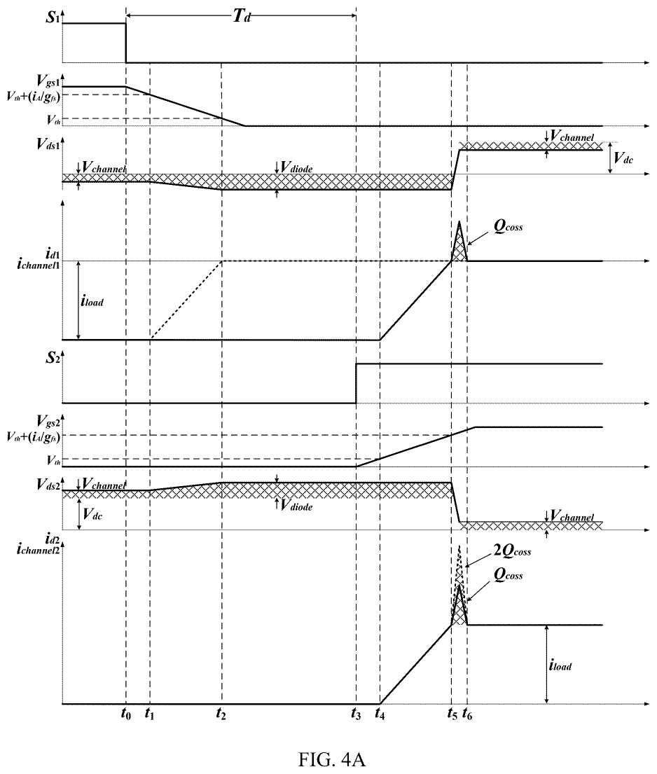

FIG. 3A is a signal timing diagram for applying pulse signals to the gates of the power devices S₁ and S₂ to complete a complete switching cycle. With reference to FIG. 2, it can be seen that the entire switching cycle includes two switching processes, where S₁ goes from off to on in a switching process 1 and S₂ goes from on to off in a switching process 2.

FIG. 3B and FIG. 3C respectively show the direction situation of the current flow of the power device S₂ during the turn-on and turn-off processes. The switching process of S₂ can be defined as a forward switching process where the parasitic output capacitor of the power device S₂ releases electric charges during the turn-on process of S₂, making the current flowing through its channel greater than the drain current, increasing the turn-on loss of the channel (in the present application, it is stipulated that when the current flows from the drain to the source, the lost energy of the power device is positive; when the current flows from the source to the drain, the lost energy of the power device is negative; when the parasitic output capacitor discharges, the lost energy of the power device is positive; when the parasitic output capacitor charges, the lost energy of the power device is negative); and where the parasitic output capacitor of the power device S₂ absorb electric charges during the turn-off process of S₂, making the current flowing through the channel less than the drain current, reducing the turn-off loss of the channel. The increased loss and decreased loss are approximately equal, so the energy of the output capacitor will not be considered as a part of the switching loss.

The structure of SiC MOSFET is different from that of S₁ IGBT (silicon-insulated gate bipolar transistor). There is a synchronous rectification mode. In this synchronous rectification mode, the current will flow in the opposite direction through the channel and its parallel diode at the same time. At this time, the SiC MOSFET will experience a reverse switching process, the above-mentioned switching process is a process that the power device S₁ goes through in a complete switching cycle. Therefore, the switching process of S₁ can be defined as a reverse switching process.

In summary, the switching process 1 can be used to simulate a process in which the power device S₁ is turned off in reverse and the power device S₂ is turned on in forward, and the switching process 2 can be used to simulate a process in which the power device S₁ is turned on in reverse and the power device S₂ is turned off in forward.

A. Analysis of Switching Losses of Power Devices S₁ and S₂ in Switching Process 1 Under Heavy Load Operating Condition

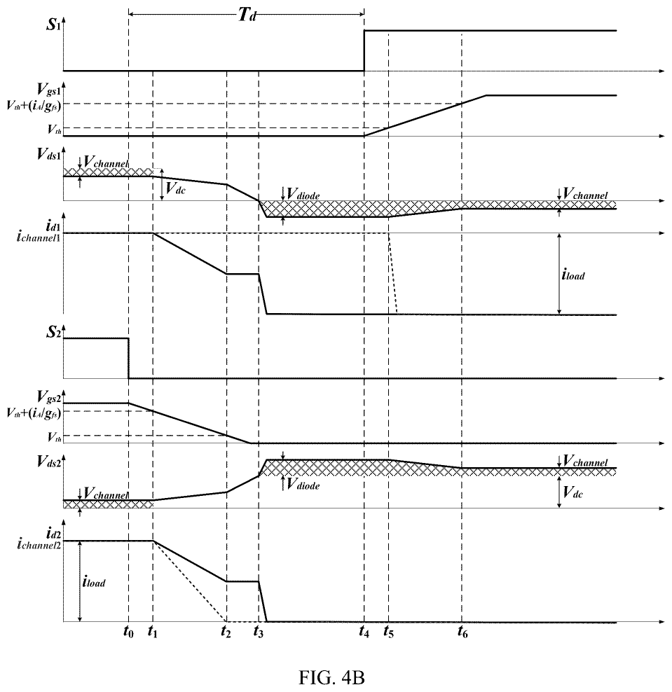

FIG. 4A shows changes in the gate signals and the voltage and the current at various locations of the power devices S₁ and S₂ in the switching process 1, where T_{d} is the dead time of the power devices S₁ and S₂, V_{gs1} is the gate-source voltage of S₁, Vₜₕ+(i_{A}/g_{fs}) is the Miller plateau voltage of the power devices S₁ and S₂, Vₜₕ is the threshold voltage of the power devices S₁ and S₂, V_{ds1} is the drain-source voltage of S₁, V_{channel} is the turn-on voltage drop of the power devices S₁ and S₂, V_{dc} is the bus voltage, V_{diode} is the turn-on voltage drop of the Schottky diodes D₁ and D₂, i_{d1} is the drain current of S₁, i_{channel1} is the channel current of S₁, Q_{COSS} is the charge stored in the parasitic output capacitor, V_{gs2} is the gate-source voltage of S₂, V_{dS2} is the drain-source voltage of S₂, i_{d2} is the drain current of S₂, i_{channel2} is the channel current of S₂.

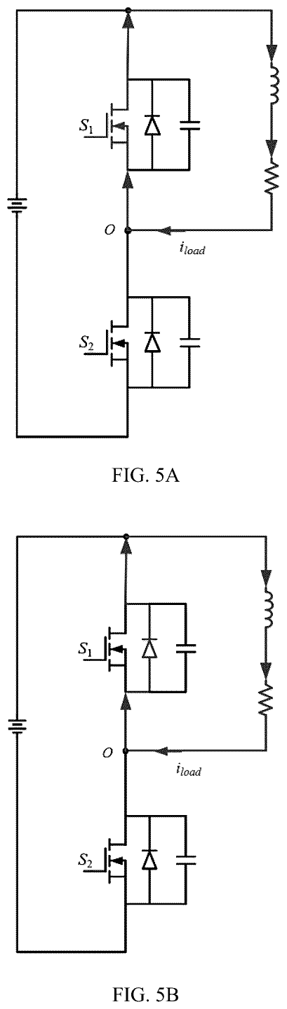

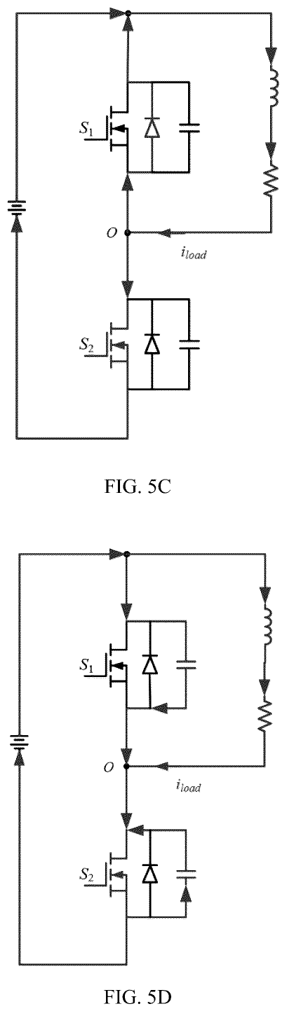

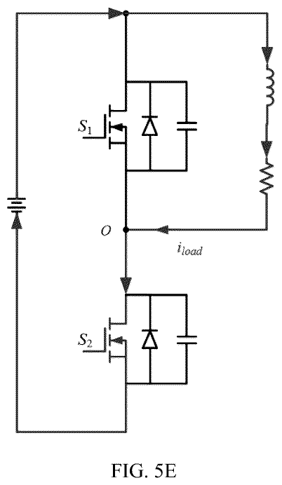

FIG. 5Aa to FIG. 5E respectively show the direction situation of the current flow of the power devices S₁ and S₂ in each interval of the switching process 1. With reference to FIG. 4A, the switching loss of the power device S₁ and S₂ in the switching process 1 under heavy load operating conditions can be analyzed.

Interval 1 (t<t₀): as shown in FIG. 5A, S₁ is turned on and S₂ is turned off. At this time, the flow of the load current is sustained by the channel of S₁ and the Schottky diode D₁.

Interval 2 (t₀−t₁): as shown in FIG. 5A, at time to, S₁ begins to be turned off, and V_{gs1} begins to decrease. In interval 2, V_{gs1} does not decrease to the Miller plateau, and the flow of the load current is still sustained by the channel of S₁ and the Schottky diode D₁, and the current path is similar to that of interval 1.

Interval 3 (t₁−t₂): as shown in FIG. 5A, at time t₁, V_{gs1} drops to the Miller plateau. At this time, the channel of S₁ begins to turn off, and the current flowing through the channel begins to decrease, the current in the Schottky diode D₁ gradually increases. In interval 3, the channel of S₁ is not completely turned off, and the flow of the load current is still sustained by the channel of S₁ and the Schottky diode D₁.

Interval 4 (t₂−t₃): as shown in FIG. 5B, at time t₂, V_{gs1} drops to the threshold voltage Vₜₕ, and the channel of S₁ is completely turned off. In interval 4, the flow of the load current is completely sustained by the Schottky Diode D₁ of S₁.

Interval 5 (t₃−t₄): as shown in FIG. 5B, at time t₃, the dead zone ends and S₂ starts to turn on. V_{gs2} begins to rise, but in interval 5, V_{gs2} is always less than the threshold voltage Vₜₕ, the load current does not flow through S₂, and the flow of the load current is still sustained by the Schottky diode D₁ of S₁.

Interval 6 (t₄−t₅): as shown in FIG. 5C, at time t₄, V_{gs2} rises to Vₜₕ and continues to rise, the channel of S₂ begins to turn on, and a part of the load current flows through the channel of S₂. In interval 6, as V_{gs2} rises, the current flowing through the channel of S₂ gradually increases, and the current flowing through the Schottky diode D₁ decreases, but the diode is always turned on, so V_{ds2} is always clamped near V_{dc}.

Interval 7 (t₅−t₆): as shown in FIG. 5D, at time t₅, V_{gs2} rises to the Miller plateau. At this time, the channel of S₂ is fully turned on, the load current completely flows through the channel of S₂, the Schottky diode D₁ is turned on, and V_{ds2} starts to fall. Since the Schottky diode D₁ is previously turned on to sustain the current flow, V_{ds2} is clamped near V_{dc}, and the charge stored in the parasitic output capacitor C₂ cannot be released. At the moment when the channel is fully turned on, the charge Q_{coss} stored in C₂ is released through the channel of S₂. At the same time, the charging current of the DC power supply to the parasitic output capacitor C₁ also flows through the channel of S₂, and a charge of 2Q_{coss} will flow through the channel and cause loss.

Interval 8 (t>t₆): as shown in FIG. 5E, after the charging and discharging processes of the output capacitors are finished, the load current completely flows through the channel of S₂ and returns to the DC power supply, and the circuit enters a steady state.

B. Analysis of Switching Losses of Power Devices S₁ and S₂ in Switching Process 2 Under Heavy Load Operating Condition

FIG. 4B shows changes in the gate signals and the voltage and the current at various locations of the power devices S₁ and S₂ in the switching process 2. The direction situation of the current flow of the power devices S₁ and S₂ in each interval of the switching process 2 can be analyzed similarly to the switching process 1.

By analyzing the current conditions of the power devices S₁ and S₂ at each stage of a complete switching cycle under heavy load operating conditions, it can be seen that due to the voltage clamping phenomenon of the Schottky diode, the actual loss of the forward turn-on process of the power device S₁ is more than the measured loss by the energy stored in output capacitors, while the actual loss of the forward turn-off process is less than the measured loss by the energy of output capacitors. The two cancel each other out, so the loss of the forward switching of the power device S₁ in a complete switching cycle is consistent with the loss obtained by the integral method, that is, there is no additional forward switching loss due to any parasitic output capacitor. At the same time, when the power device S₁ undergoes a complete switching cycle under heavy load operating conditions, due to the parasitic output capacitor being completely discharged, the loss obtained by the integral method is basically consistent, that is, the additional reverse switching loss is almost zero.

C. Analysis of Switching Losses of Power Devices S₁ and S₂ in Switching Process 2 Under Light Load Operating Condition

Generally speaking, when the output current is less than or equal to 10% of the rated operating point current, it can be considered to be in a light load operating condition. Compared with heavy load operating conditions, in light load operating conditions, the load current in the circuit will be much smaller because the voltage clamping phenomenon of the Schottky diode will still occur in process 1. Therefore, the forward turn-on process of S₁ and the reverse turn-off process of S₂ under light load operating conditions are similar to those under heavy load operating conditions. The forward turn-on loss of S₁ and the reverse turn-off loss of S₂ under light load operating conditions have no difference from those under heavy load operating conditions.

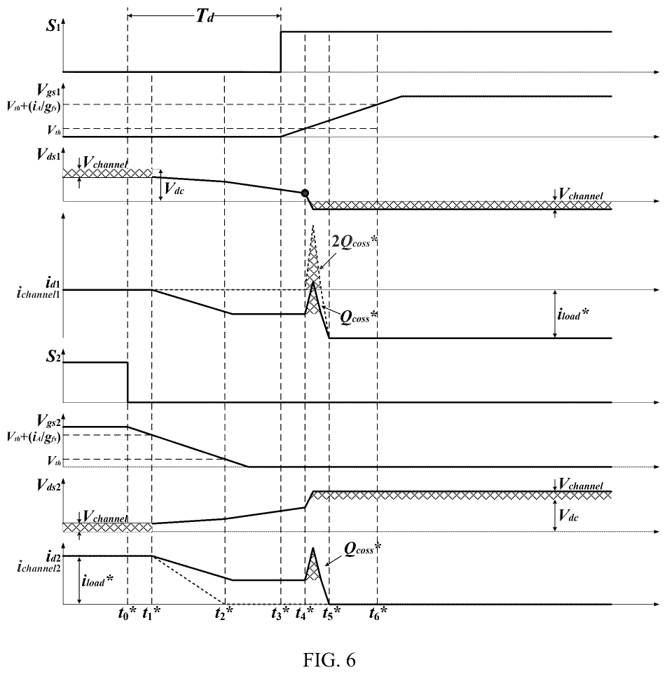

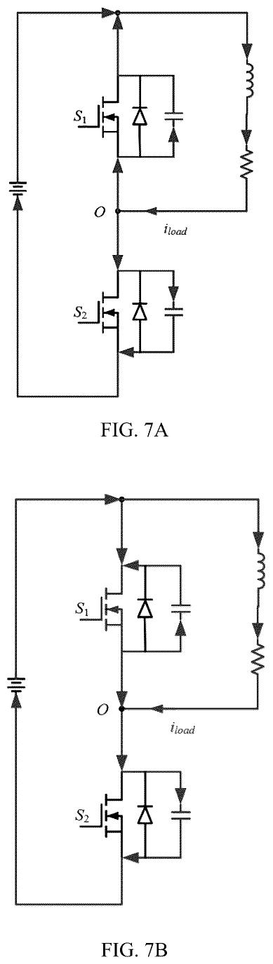

FIG. 6 shows changes in the gate signals and the voltage and the current at various locations of the power devices S₁ and S₂ in the switching process 2 under light load operating conditions. FIG. 7A and FIG. 7B respectively show the direction situation of the current flow at various locations of the power devices S₁ and S₂ at time t₃*−t₄* and time t₄*−t₅* of the switching process 2.

From FIG. 6, FIG. 7A, and FIG. 7B, it can be seen that the difference between the switching losses of the power devices S₁ and S₂ under light load operating conditions and those under heavy load operating conditions is mainly that under heavy load operating conditions, at time t₃ which is before the dead time T_{d} ends, the drain-source voltage V_{ds} of S₁ has dropped to zero. However, under light load operating conditions, at time t₄* which is after the dead zone ends, the drain-source voltage V_{ds} of S₁ still has not dropped to zero.

t₃*−t₄*: as shown in FIG. 7A, under light load operating conditions, the load current is small. Although the load current is all used to charge and discharge the parasitic output capacitor during the dead time, at time t₄, there is still part of the charge is stored in the parasitic output capacitor C₁, and the drain-source voltage V_{ds1} of S₁ does not drop to zero.

t₄*−t₅*: as shown in FIG. 7B, at time t₄*, the channel of S₁ begins to turn on. At the moment when the channel is turned on, part of the charge Q_{coss}* stored in the parasitic output capacitor C₁ is released through the channel of S₁. At the same time, the charging current of the power supply to the output capacitor C₂ of S₂ also flows through the channel of S₁, and there will be a loss generated by the charge of 2Q_{coss}*.

By analyzing the current situation of the power devices S₁ and S₂ at each stage of a complete switching cycle under light load operating conditions, it can be seen that due to the light load operating condition, at time t₄* which is after the dead zone ends, there is still a part of charge stored in the parasitic output capacitor C₁, so that the drain-source voltage V_{ds} of S₁ still does not drop to zero, causing part of the charge Q_{coss}* stored in the parasitic output capacitor C₁ to be released through the channel of S₁. Therefore, when the power device S₁ undergoes a complete switching cycle under light load operating conditions, since the parasitic output capacitor is not fully discharged, the actual reverse switching loss will be larger than the loss obtained by the integral method, that is, the inadequate discharge of the parasitic output capacitor under light load operating conditions is the main reason for the additional reverse switching loss of the power device S₁.

### [H-Bridge Type Parallel Multi-Level Inverter Switch Module and Inverter Using the Switch Module]

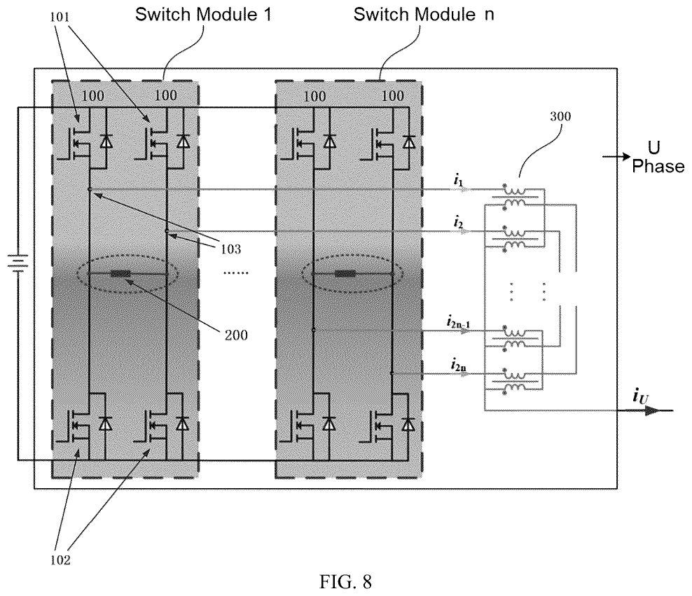

Aiming at the causes of additional reverse switching loss in the parallel multi-level inverter constructed with silicon carbide based power devices, the present application improves the existing inverter structure. FIG. 8 shows the topology of the U-phase control part of the inverter provided according to some embodiments of the present application. As shown in FIG. 8, the U-phase control part of the inverter includes n H-bridge type parallel multi-voltage inverter switch modules, which are marked as switch module 1, . . . , and switch module n respectively.

As shown in FIG. 8, the switch module 1 includes two switching units 100 connected in parallel, and an H-bridge inductor 200.

Each switching unit 100 is equivalent to a parallel switching branch in FIG. 1 and includes a first power device 101 and a second power device 102 connected in series, where the source of the first power device 101 is connected to the drain of the second power device 102, and this connection point is used as a neutral point 103 of the switching unit. In some embodiments, as shown in FIG. 8, a branch current i₁ is led out of the neutral point 103 of the switching unit 100 on the left of the switch module 1 and flows to the cascaded coupling network 300, and a branch current i₂ is led out of the neutral point 103 of the switching unit 100 on the right and flows to the cascaded coupling network 300. The branch current i₂ₙ₋₁ is led out of the neutral point 103 of the switching unit 100 on the left of the switch module n and flows to the cascaded coupling network 300, and the branch current i₂ₙ is led out of the neutral point 103 of the switching unit 100 on the right and flows to the cascaded coupling network 300. The remaining branch currents flow to the cascaded coupling network 300 in FIG. 8 in the same way.

The drains of the first power devices 101 of the two switching units 100 are connected to each other, and the sources of the second power devices 102 of the two switching units 100 are connected to each other. During the actual inversion process, the drain of each first power device 101 mentioned above is connected to the positive pole of the DC power supply, and the source of each second power device 102 is connected to the negative pole of the DC power supply, thereby forming a parallel multi-level switching topology similar to FIG. 1. In some embodiments, according to the aforementioned analysis, the switching process performed by the two first power devices 101 is a reverse switching process, and the switching process performed by the two second power devices 102 is a forward switching process.

As shown in FIG. 8, two ends of the H-bridge inductor 200 included in the switch module 1 are connected to the neutral points of the two switching units 100 respectively to suppress the additional reverse switching loss generated by the two first power device 101 in the switch module during the reverse switching process.

The topological structure of the V-phase and W-phase control parts is the same as that of the U-phase control part in FIG. 8, and will not be described again here.

It should be noted that in the embodiment shown in FIG. 8, the control part of each phase includes n H-bridge type parallel multi-level inverter switch modules, where the minimum value of n can be 1, that is, one-phase inverter circuit can be controlled by only one of the above-mentioned H-bridge type parallel multi-level inverter switch modules.

In some preferred embodiments, the first power device 101 and the second power device 102 are both high-level turn-on silicon carbide based power devices, that is, high-level turn-on SiC MOSFETs. In other optional embodiments, the first power device 101 and the second power device 102 can also be other power switching devices with similar characteristics of channel+diode+parasitic output capacitor.

In some preferred embodiments, the first power device 101 and the second power device 102 can use devices with the same specifications. Selecting devices with the same specifications can effectively reduce product manufacturing costs and make it easier to determine the optimal inductance value of the H-bridge inductor 200.

### [Suppression of Additional Reverse Switching Loss by H-Bridge Inductor]

The analysis model of the H-bridge type parallel multi-level inverter switch module can be established in a similar way to the analysis model of the previous double-pulse switching circuit to analyze its suppression mechanism of the additional reverse switching loss. In order to more clearly illustrate this analysis model, in FIG. 8, the first power device 101 of the switching unit on the left side of the switch module 1 can be marked as Sₕ₁, the second power device 102 on the left side of the switch module 1 can be marked as Sₗ₁, the first power device 102 of the switching unit on the right side of the switch module 1 can be marked as Sₕ₂, and the second power device 102 on the right side can be marked as Sₗ₂. In some embodiments, each power device includes a high-level turn-on channel and a Schottky diode, and has a parasitic output capacitor.

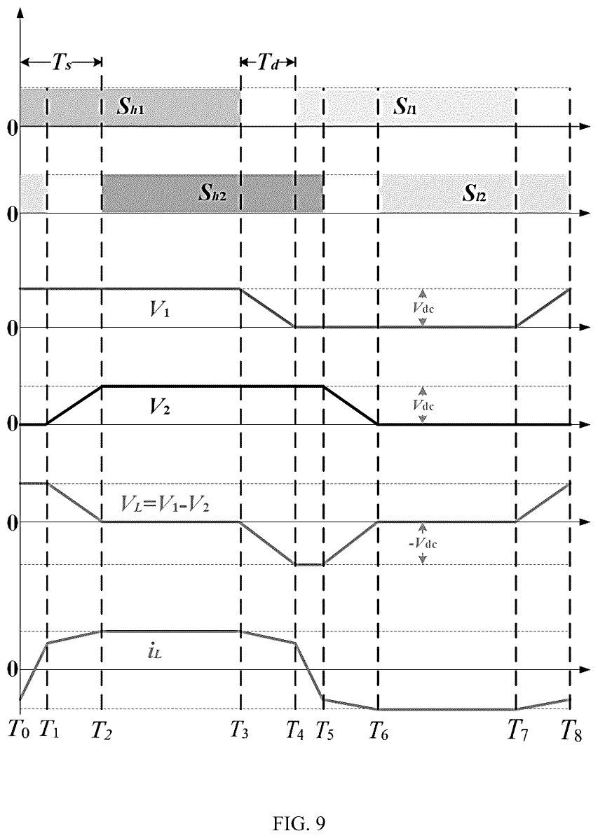

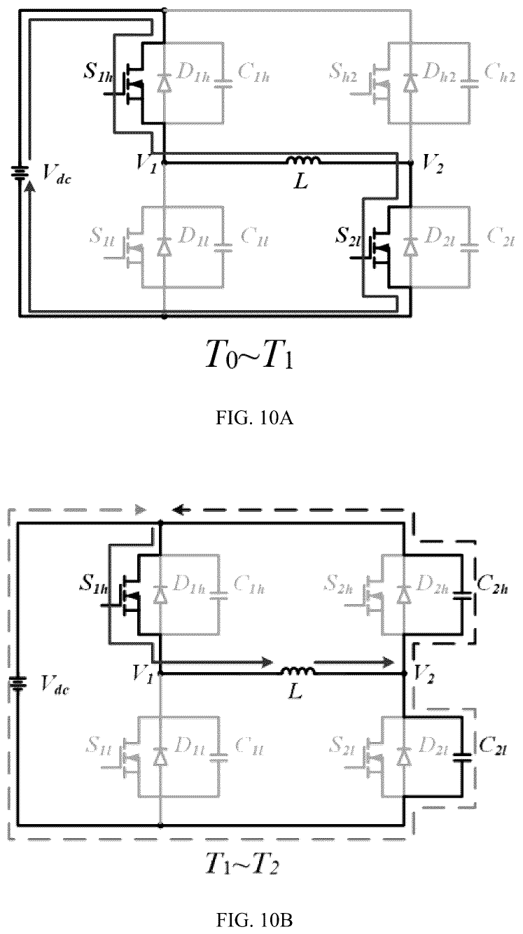

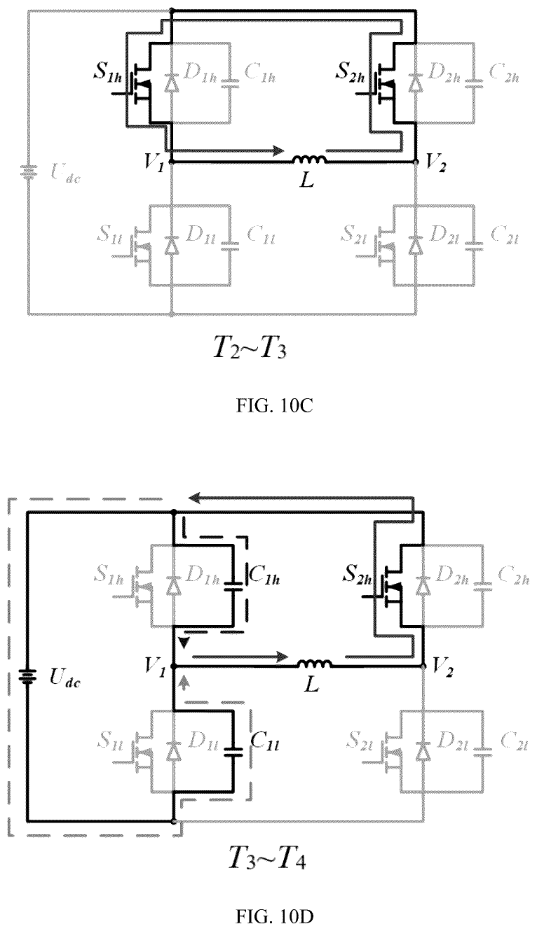

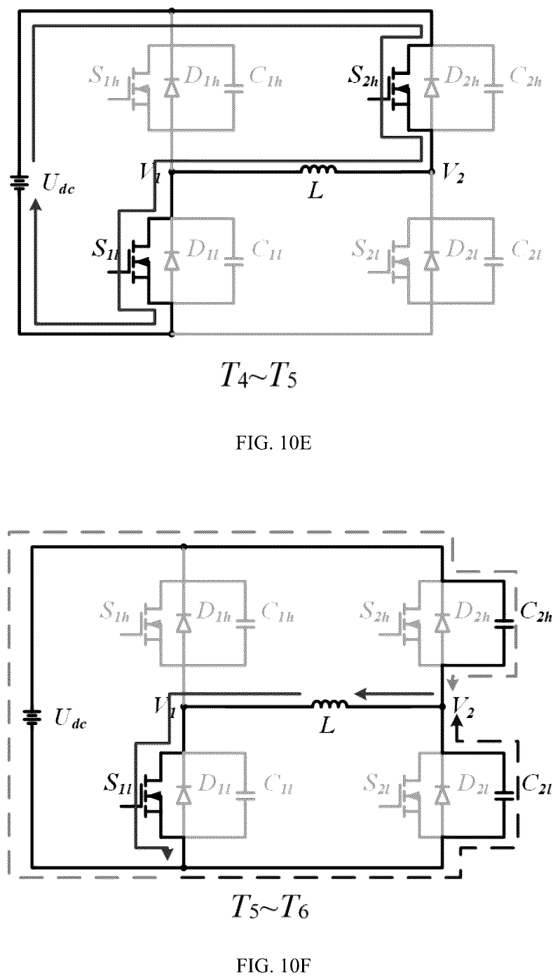

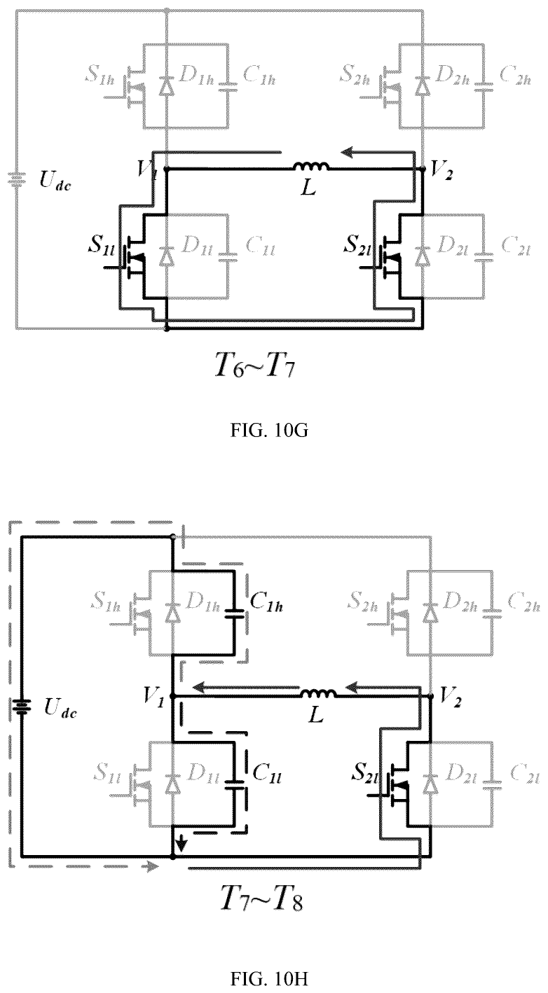

FIG. 9 shows the changes of the gate signals and the voltage and the current of Sₕ₁, Sₕ₂, Sₗ₁, and Sₗ₂ in a complete switching cycle. FIG. 10A to FIG. 10H show the direction situation of the current flow of Sₕ₁, Sₕ₂, Sₗ₁, and Sₗ₂ in each interval respectively. Tₛ and T_{d} in the figure are the phase shift time and the dead time of each power device respectively. The switching losses of Sₕ₁, Sₕ₂, Sₗ₁, and Sₗ₂ at each interval can be analyzed in combination with FIG. 9 and FIG. 10A to FIG. 10H.

Interval I (T₀˜T₁): as shown in FIG. 10Aa, at this time, Sₕ₁ of the left branch and Sₗ₂ of the right branch are turned on. Compared with the DC bus voltage, the voltage drop of Sₕ₁ and Sₗ₂ is negligible. Therefore, the voltage difference V₁₂ at the neutral point of the switch is equal to the DC bus voltage V_{dc}, causing the inductor current i_{L} of the H-bridge inductor to rise linearly.

Interval II (T₁˜T₂): as shown in FIG. 10B, only Sₕ₁ is turned on at this time, and the right branch is in the dead zone stage. Since the inductor current i_{L} of the H-bridge inductor cannot change suddenly, i_{L} reversely charges the parasitic output capacitor Cₕ₂ and charges the parasitic output capacitor Cₗ₂ at the same time. Under ideal circumstances, at the end of interval II, Cₕ₂ and Cᵢ₂ can achieve complete charge and discharge, so that the voltage of Sₕ₂ decreases from V_{dc} to 0, and Sₗ₂ increases from 0 to V_{dc}, thus realizing the zero-voltage turn-on process of the right branch Sₕ₂. At this time, the voltage across the H-bridge inductor drops from V_{dc} to 0, and i_{L} will increase.

Interval III (T₂˜T₃): as shown in FIG. 10C Sₕ₁ and Sₕ₂ are turned on at this time, and the flow of i_{L} is sustained by the channel of Sₕ₁. If the parasitic output capacitors Cₕ₂ and Cₗ₂ have been charged and discharged in interval II, i_{L} will not flow through the parasitic output capacitors. Therefore, in interval III, the voltage across the H-bridge inductor is the voltage drop between Dₕ₂ and Sₕ₁, and i_{L} will drop slightly, which can be ignored.

Interval IV (T₃˜T₄): as shown in FIG. 10D, only Sₕ₂ is turned on at this time, and the left branch is in the dead zone stage. i_{L} charges Cₕ₁ and discharges Cₗ₂. Under ideal circumstances, Cₕ₁ and Cₗ₁ can be completely charged and discharged, so that the voltage of Sₕ₁ increases from 0 to V_{dc} and the voltage of Su decreases from V_{dc} to 0, thereby realizing the zero-voltage turn-on process of the left branch Su. At this time, the voltage across the H-bridge inductor reversely increases from 0 to −V_{dc}, and i_{L} will decrease.

Interval V (T₄˜T₅): as shown in FIG. 10E, at this time, Su of the left branch and Sₕ₂ of the right branch are turned on, the bus voltage continues to reversely charge the H-bridge inductor, and i_{L} decreases to 0 and continues to increase in the opposite direction.

Interval VI (T₅˜T₆): as shown in FIG. 10F, at this time, only Su is turned on, and the right branch is in the dead zone stage. i_{L} charges Cₕ₂ and discharges Cₗ₂. Under ideal circumstances, Cₕ₂ and Cₗ₂ can be completely charged and discharged, so that the voltage of Sₕ₂ increases from 0 to V_{dc} and the voltage of Sₗ₂ increases decreases from V_{dc} to 0, thereby realizing the zero-voltage turn-on process of the right branch Sₗ₂. At this time, the voltage across the H-bridge inductor decreases from −V_{dc} to 0, and i_{L} will decrease.

Interval VII (T₆˜T₇): as shown in FIG. 10G, at this time, Su and Sₗ₂ are turned on, and the flow of i_{L} is sustained by the channel of Su. If the output capacitors Chi and Cn have been charged and discharged in interval VI, i_{L} will not flow through the output capacitors. In interval VII, the voltage across the H-bridge inductor is the voltage drop between Dₗ₂ and Sₗ₁, and i_{L} will drop slightly, which can be ignored.

Interval VIII (T₇˜T₈): as shown in FIG. 10H, only Sₗ₂ is turned on at this time, and the left branch is in the dead zone stage. i_{L} discharges Cₕ₁ and charges Cₗ₁. Under ideal circumstances, Cₕ₁ and Cₗ₁ can be completely charged and discharged, so that the voltage of Sₕ₁ is reduced from V_{dc} to 0, and the voltage of Su increases from 0 to V_{dc}, thereby realizing the zero-voltage turn-on process of the left branch Sₕ₁. At this time, the voltage across the H-bridge inductor increases from 0 to V_{dc}, and i_{L} will increase from negative current to positive current.

From the above analysis, it can be seen that by connecting the H-bridge resistor at the neutral point of the two parallel branches, each parasitic output capacitor can be charged and discharged symmetrically in each interval of a complete switching cycle. Under ideal circumstances, complete charging and discharging can be achieved. That is, zero-voltage switching (ZVS) of each power device is realized. Therefore, the additional reverse switching loss caused by the inability of the parasitic output capacitor in the power device to discharge in time under light load operating conditions can be effectively suppressed, and overall, the switching loss of parallel multi-level inverters is reduced.

### [Parameter Optimization of H-Bridge Inductor]

It can be seen from the above analysis that the purpose of setting up the H-bridge inductor is to reduce the reverse switching loss of the power device under light load operating conditions by charging and discharging the parasitic output capacitor, so as to achieve the purpose of zero-voltage switching (ZVS). To achieve the above purpose, the inductance value of the H-bridge inductor should be optimized to ensure that the parasitic output capacitor of each power device can be fully charged and discharged during a complete switching cycle under light load operating conditions, thereby achieving the purpose of minimizing the reverse switching loss.

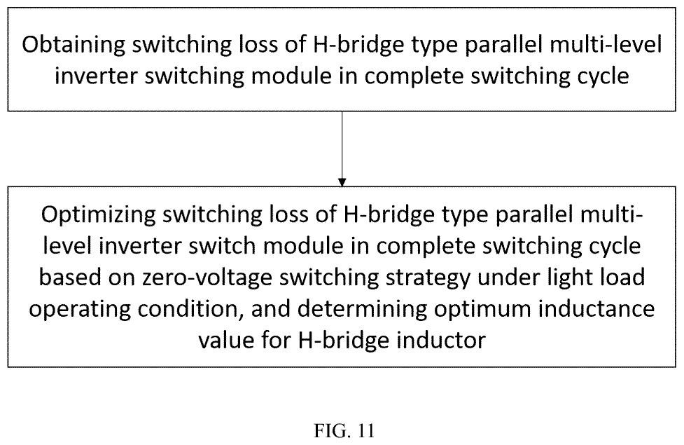

To this end, some embodiments of the present application also provide a method for optimizing the above-mentioned H-bridge type parallel multi-level inverter switch module. As shown in FIG. 11, the method for optimizing the above-mentioned H-bridge type parallel multi-level inverter switch module includes the following steps.

Step 1: obtaining the switching loss of the H-bridge type parallel multi-level inverter switching module in a complete switching cycle.

Step 2: optimizing the switching loss of the H-bridge type parallel multi-level inverter switch module in a complete switching cycle based on the zero-voltage switching strategy under light load operating conditions, and determining an optimum inductor value of the H-bridge inductor.

In some embodiments, the specific implementation of step 1 has been explained in the introduction of FIG. 9 and FIG. 10A to FIG. 10H. Through the above analysis, it can be found that the zero-voltage switching process of the switch module 1 under light load operating conditions is a process to charge and discharge the parasitic output capacitors of the two power devices of the left (or right) switching unit respectively through the H-bridge inductor in intervals II, IV, VI, and VIII, thereby reducing additional reverse switching loss. Therefore, in order to achieve an ideal loss reduction effect, it is necessary to match the inductance value of the H-bridge inductor with the parameters of the power devices to ensure that when the inverter circuit reaches a steady state under light load operating conditions, the H-bridge type parallel multi-level inverter switch module satisfies the following constraints.

The first constraint is that the inductor current at the beginning of a complete switching cycle is equal to the inductor current at the end of the switching cycle.

The second constraint is that the voltage at two ends of the H-bridge inductor changes symmetrically within a complete switching cycle;

The third constraint is that the reverse switching loss of the first power device of each switching unit is minimal within a complete switching cycle.

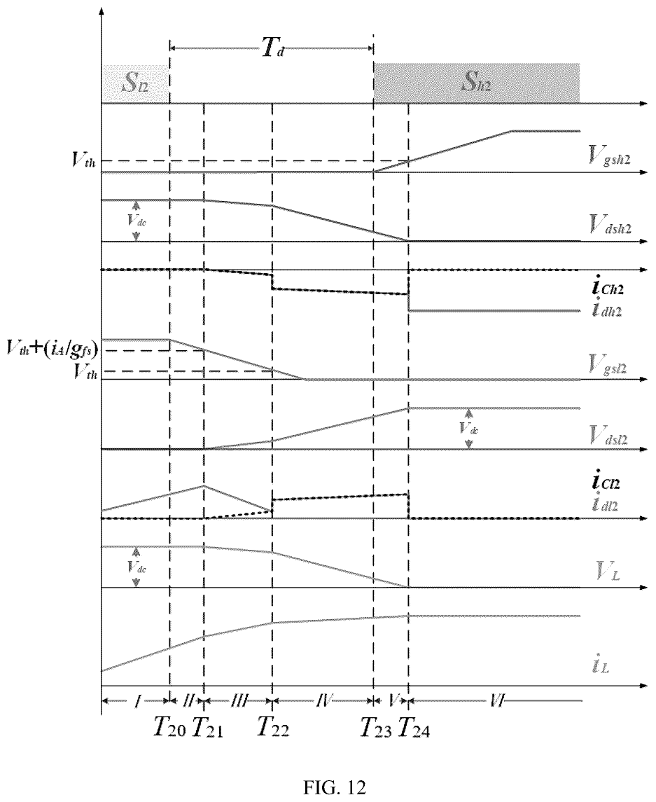

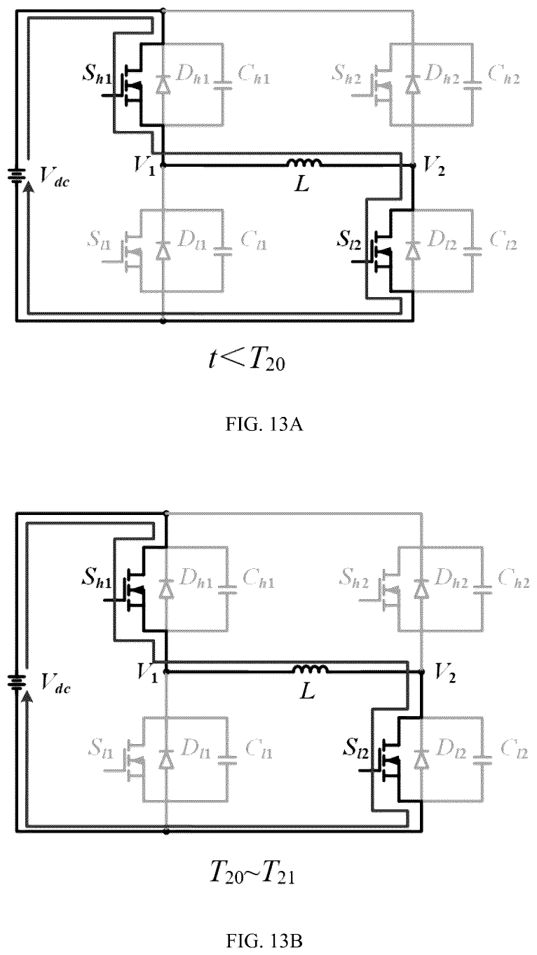

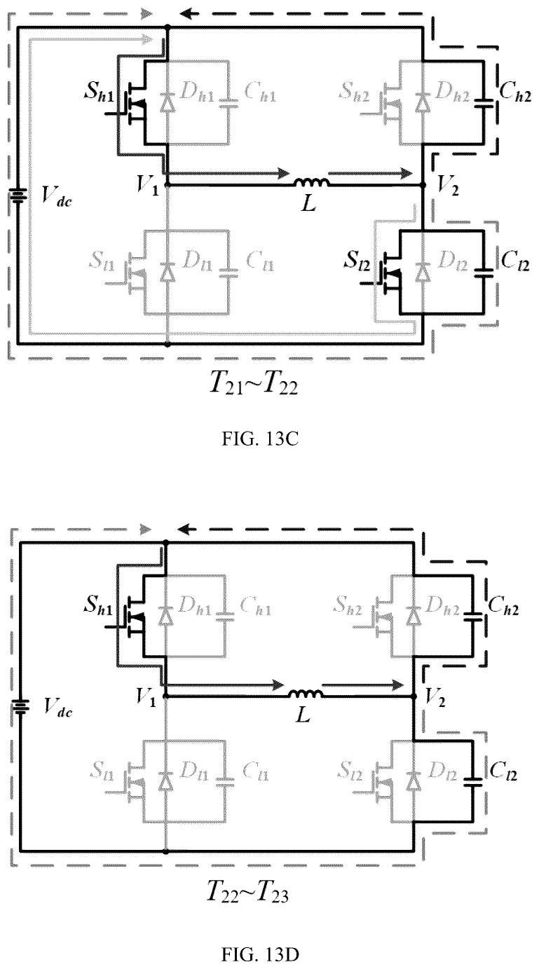

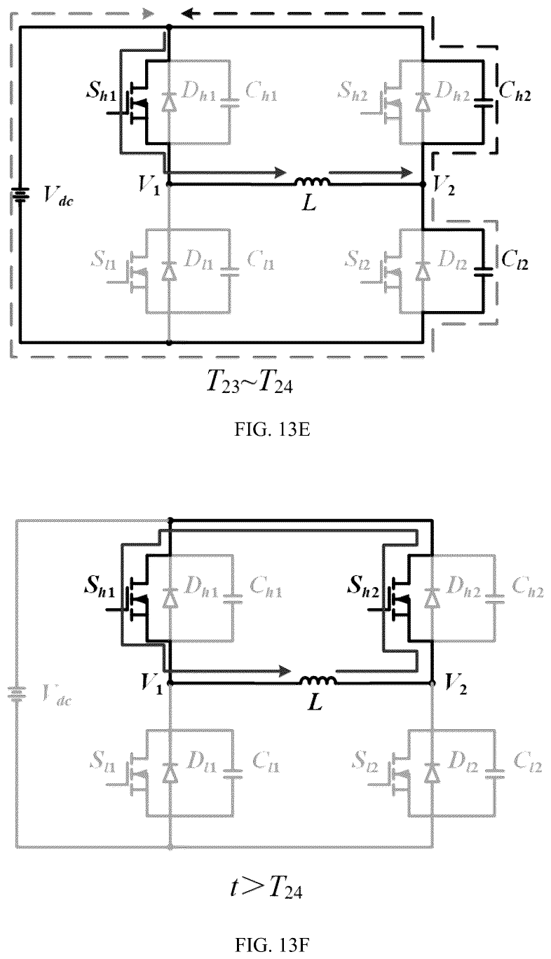

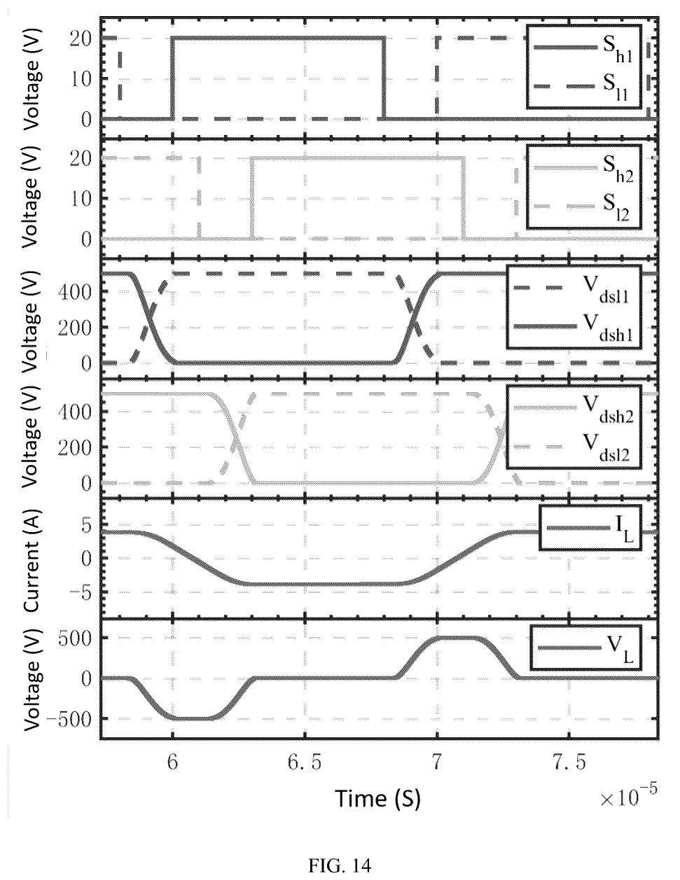

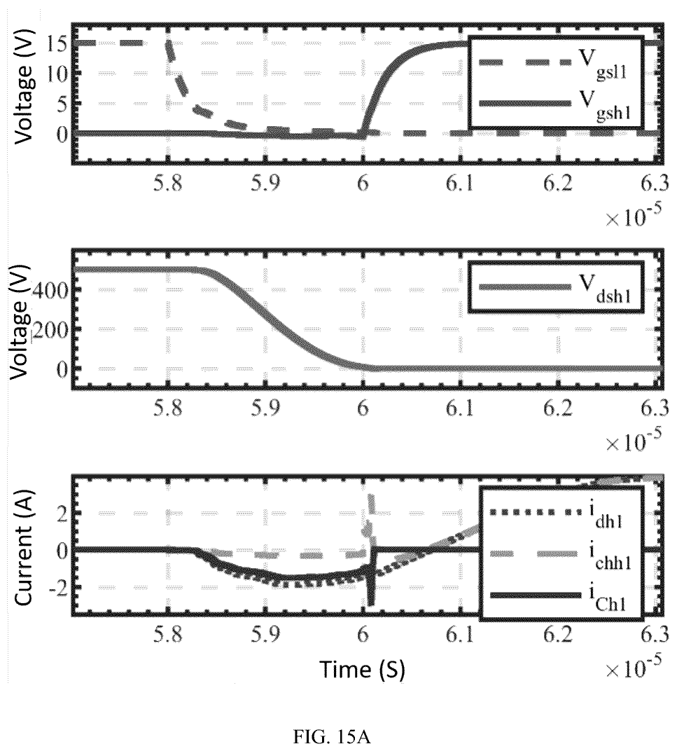

FIG. 12 shows the changes in the gate signal and the voltage and the current of the H-bridge type parallel multi-level inverter switching module in interval II. FIG. 13A to FIG. 13F respectively show the direction situation of the current flow of the switching module in stage I to stage VI of interval II. The specific process of H-bridge inductor optimization based on the above zero-voltage switching strategy in step 2 will be illustrated below in combination with the attached figures by taking interval II as an example.

Stage I (t<T₂₀): at this time, interval II has not yet started, the switch module is in the state in FIG. 13A, the voltage difference V₁₂ across the H-bridge inductor is equal to the DC bus voltage V_{dc}, which makes the inductor current i_{L} increase linearly. The inductor current at time T₂₀ can be solved by the following formula:

$${i}_{L {T}_{20}} = \frac{1}{2} \cdot \frac{{V}_{d c}}{L} \cdot {T}_{0} \qquad ( 1 )$$

$${T}_{0} = {T}_{s} - {T}_{d} .$$

Stage II (T₂₀˜T₂₁): as shown in FIG. 13B, at this time, the gate drive voltage of Sₗ₂ changes from high to low, and the gate voltage V_{gsl2} drops from V_{gsmax} to the Miller plateau voltage Vₜₕ+(i_{A}/g_{fs}). Similar to stage I, the inductor current i_{L} in stage II still increases linearly. Therefore, the analysis of stage II is described as follows:

$${i}_{L {T}_{21}} = {i}_{L {T}_{20}} + \frac{{V}_{d c}}{L} \cdot ( {T}_{21} - {T}_{20} ) \qquad ( 2 )$$

$${T}_{21} - {T}_{20} = {R}_{g} {C}_{iss} ln ( \frac{{V}_{gsmax}}{{V}_{t h} + {i}_{A} / {g}_{fs}} ) ,$$

Where R_{g} and Cᵢₛₛ are the gate drive resistance and the input capacitance of the power device respectively.

Stage III (T₂₁˜T₂₂): as shown in FIG. 13C, at this time, the gate voltage V_{gsl2} of Sₗ₂ drops from Vₜₕ+ (i_{A}/g_{fs}) to the Miller plateau and then to the threshold voltage Vₜₕ. At this time, i_{L} begins to discharge the parasitic output capacitor Cₕ₂ and charge Cₗ₂, causing the drain-source voltage V_{dsh2} of Sₕ₂ to decrease and the drain-source voltage V_{dsl2} of Sₗ₂ to increase. However, in this stage, i_{L} mainly flows through the channel of Sₗ₂, thus the caused voltage change can be ignored. Therefore, the description of stage III is as follows:

$${i}_{L {T}_{22}} = {i}_{L {T}_{21}} + \frac{{V}_{d c}}{L} \cdot ( {T}_{22} - {T}_{21} ) \qquad ( 3 )$$

$${T}_{22} - {T}_{21} = {R}_{g} {C}_{i s s} ln ( \frac{{V}_{t h} + {i}_{A} / {g}_{fs}}{{V}_{t h}} ) .$$

Stage IV (T₂₂˜T₂₃): as shown in FIG. 13D, at this time, the gate voltage V_{gsl2} of Sₗ₂ drops below the threshold voltage Vₜₕ, and the channel of Sₗ₂ is completely turned off. At this time, i_{L} is completely used to discharge the parasitic output capacitor Cₕ₂ and charge Cₗ₂, causing V_{dsh2} to drop quickly and V_{dsl2} to rise quickly.

Stage V (T₂₃˜T₂₄): as shown in FIG. 13E, the dead zone ends at T₂₃, the gate drive signal of Sₕ₂ changes from low to high, the gate voltage V_{gsh2} of Sₕ₂ starts to rise from 0. But in stage V, the gate voltage V_{gsh2} of Sₕ₂ is below the threshold voltage Vₜₕ, and the channel is not turned on. At this time, i_{L} is still used to discharge the parasitic output capacitor Cₕ₂ and charge Cₗ₂, causing V_{dsh2} to drop to 0 and V_{dsl2} to rise to V_{dc} at time T₂₄.

The analysis of Stage IV and Stage V is described below:

$${i}_{L {T}_{24}} = {i}_{L {T}_{22}} + \frac{{U}_{d c}}{L} \cdot ( {T}_{24} - {T}_{22} ) \qquad ( 4 )$$

$${T}_{24} - {T}_{23} = {R}_{g} {C}_{i s s} ln ( \frac{{V}_{gs}}{{V}_{gsmax} - {V}_{th}} ) .$$

Stage VI (t>T₂₄): as shown in FIG. 13F, at time T₂₄, the gate voltage V_{gsh2} of Sₕ₂ rises to the threshold voltage Vₜₕ, and the channel of Sₕ₂ is turned on. At this time, all processes in interval II have ended. The inductor current i_{L} is sustained by the channel of Sₕ₂ and flows back to the inductor through Sₕ₁.

The above are the six processes of interval II. It can be seen from it that the inductor current i_{L} mainly charges and discharges the parasitic output capacitors in stage IV and stage V, so that the drain-source voltage V_{dsh2} of Sₕ₂ of the right branch drops to zero before the channel is turned on, achieving zero-voltage turn-on of Sₕ₂. In both processes, the charge flowing through the H-bridge inductor is equal to the charge transferred between the two parasitic output capacitors:

$$\frac{1}{2} \cdot ( {i}_{L {T}_{22}} + {i}_{L {T}_{24}} ) \cdot ( {T}_{24} - {T}_{22} ) = 2 {C}_{o s s} \cdot {V}_{d c} , \qquad ( 5 )$$

where Cₒₛₛ is the output capacitance of the power device.

By substituting equations (1) to (4) into equation (5), the relationship between the optimal estimated value of the H-bridge inductor and the specifications of the power device can be obtained as in equation (6):

$$8 L \cdot {C}_{o s s} = ( 2 {T}_{s} - {T}_{d} + 3 {R}_{g} \cdot {C}_{iss} \cdot ln \frac{{V}_{g s}}{{V}_{t h}} + {R}_{g} \cdot {C}_{i s s} \cdot ln \frac{{V}_{g s}}{{V}_{g s} - {V}_{t h}} ) \times ( {T}_{d} + {R}_{g} \cdot {C}_{i s s} \cdot ln \frac{{V}_{t h}}{{V}_{g s} - {V}_{t h}} ) . \qquad ( 6 )$$

Selecting the H-bridge inductor based on the above-mentioned optimal inductance value enables the switch module to achieve the ideal effect of suppressing additional reverse switching losses under light load operating conditions.

In some embodiments, a simulation is performed. In this simulation, an inverter structure with two branches connected in parallel and the new “H-bridge” structure provided by this application are used to verify that this structure can achieve zero-voltage turn-on of the power device in principle, thereby achieving the purpose of reducing power device losses under light load operating conditions. Table 1 lists the experimental parameters of this verification embodiment.

TABLE 1
Parameters of Verification Embodiment

| Parameter | Value | Unit |
|---|---|---|
| Bus Voltage(V_{dc}) | 500 | V |
| Switching Period(T) | 20 | μs |
| Dead Time(T_{d}) | 2 | μs |
| Phase Shift Time (T_{S}) | 3.3 | μs |
| Input Capacitance (Cᵢₛₛ) | 20 | nF |
| Output Capacitance (Cₒₛₛ) | 3 | nF |

After calculating the optimal inductance value of the H-bridge inductor through the parameters in Table 1, the corresponding simulation model is built using the topology shown in FIG. 8. FIG. 14 shows the waveform diagrams of the driving signals of the power devices, the drain-source voltages of the power devices, the voltages of the H-bridge inductors, the currents of the H-bridge inductors of the parallel inverters in two branches. It can be seen from FIG. 14 that the drain-source voltages of the four parallel SiC MOSFETs all drop to zero during the dead time, creating conditions for zero-voltage turn-on.

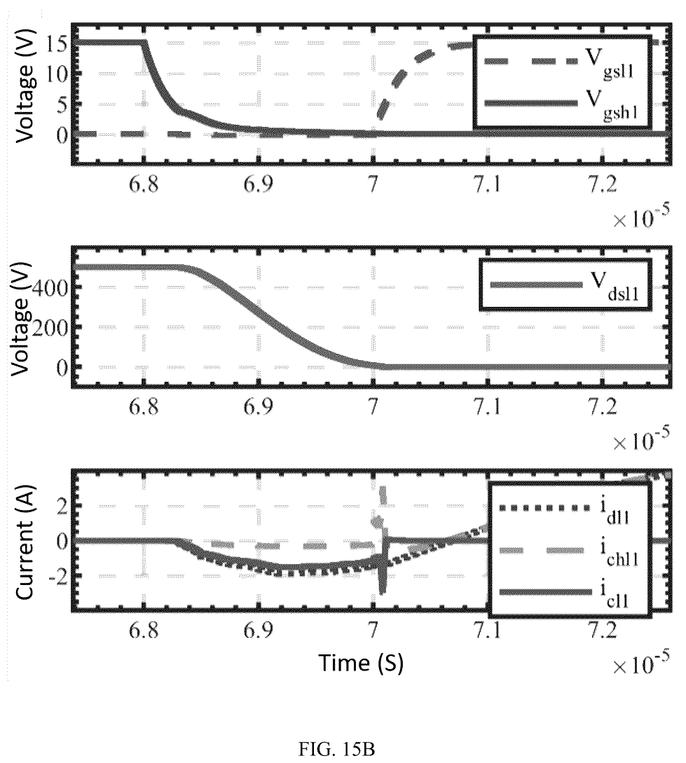

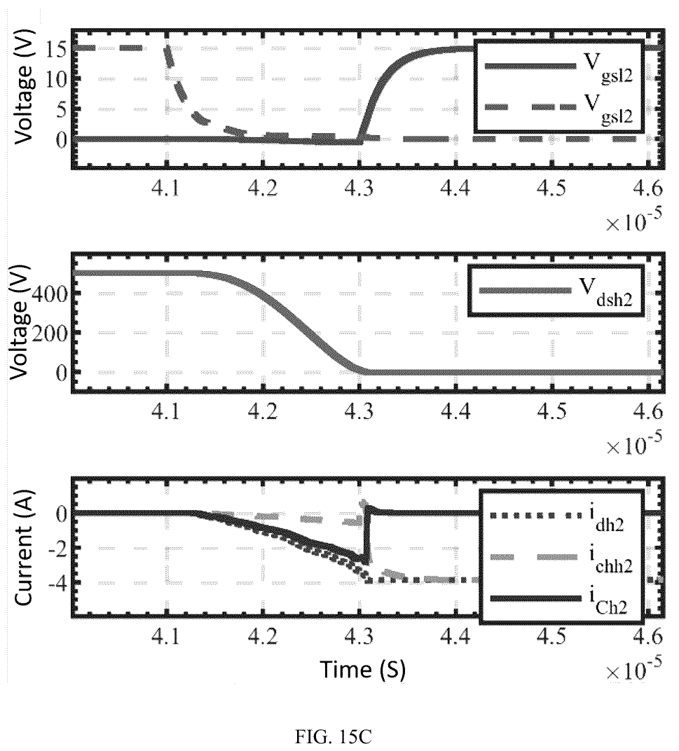

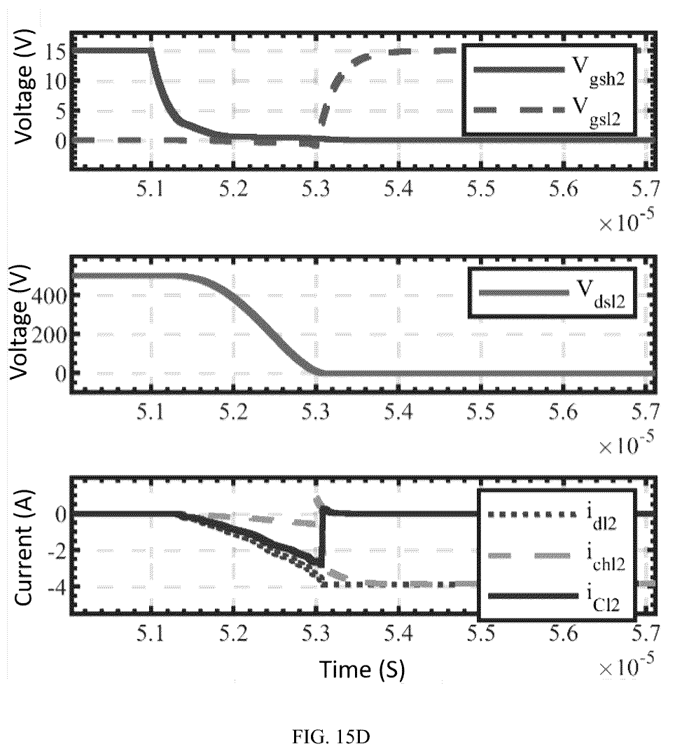

FIG. 15 shows the detailed ZVS waveforms of four power devices, including a driving voltage waveform, a drain-source voltage waveform, a drain current waveform, a channel current waveform, and an output capacitance waveform of each power device, where (a) is an upper bridge waveform of the left branch, (b) is a lower bridge waveform of the left branch, (c) is an upper bridge waveform of the right branch, and (d) is a lower bridge waveform of the right branch. As can be seen from FIG. 15, before the channel of each SiC MOSFET is turned on, the inductor current discharges the output capacitor, causing the drain-source voltage across two ends of the switching transistor to drop to zero, achieving zero-voltage turn-on, thereby reducing switching losses.

In some embodiments, an experiment is adopted. In this experiment, an inverter structure with two branches connected in parallel and the new H-bridge structure provided by this application are used to verify that this structure can achieve zero-voltage turn-on of the power devices on a real platform, achieving the purpose of reducing the loss of the power device under light load operating conditions. The experimental parameters are the same as those in the verification embodiment 1.

In some embodiment, one of the two bridge arms is taken as an example. The driving voltage and the drain-source voltage of the bridge arm as well as the “H-bridge” inductor current at the same time are measured to analyze the feasibility of zero-voltage turn-on.

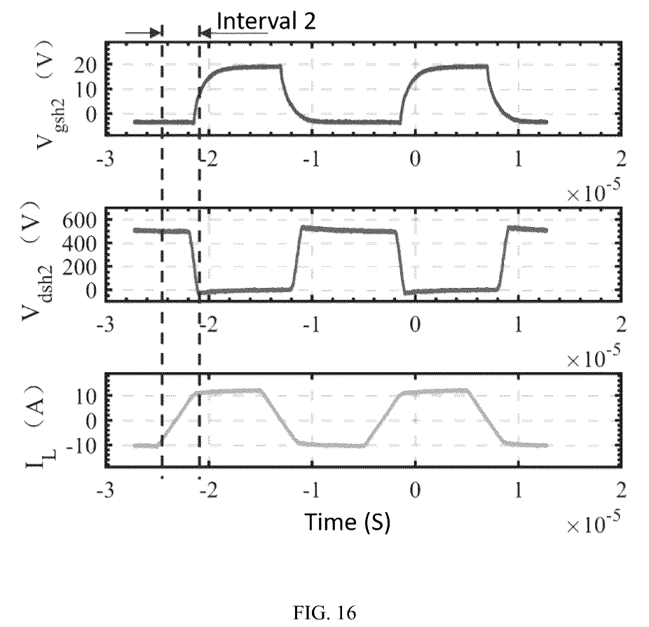

FIG. 16 shows the waveform diagrams of the driving voltage and the drain-source voltage of the bridge arm on the right branch of the inverter as well as the H-bridge inductor current at the same time. It can be seen from FIG. 16 that after constructing the H-bridge inductor, before the channel of the SiC MOSFET is turned on, the drain-source voltage V_{dsh2} has dropped to zero, achieving zero-voltage turn-on. The change process of the inductor current also shows a quadrilateral circulation change, which is consistent with the theoretical derivation.

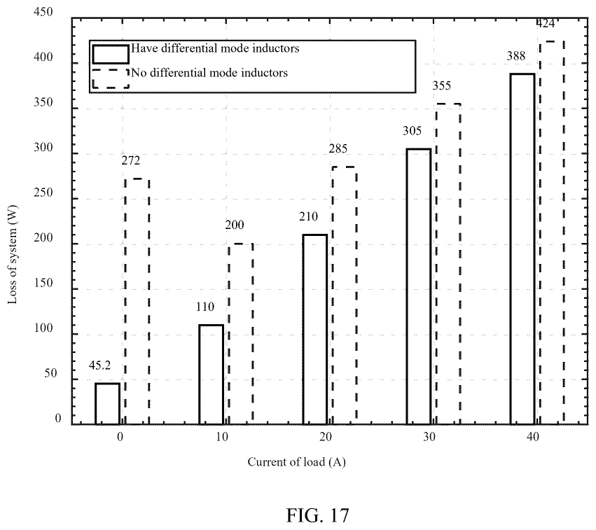

FIG. 17 is a chart of the comparison between the system loss of the two-branch inverter with an inductor added to achieve zero-voltage turn-on of SiC MOSFET and the system loss of hard switching without an inductor. It can be seen from FIG. 17 that under light load operating conditions, with the H-bridge structure proposed in the present application used, the inverter loss is significantly reduced compared to the loss of the traditional structure; under no-load conditions, i.e., when the load current is zero, the system loss is greatly reduced after using the H-bridge structure. Compared with the hard switching strategy, the system loss is reduced by 83%.

The technical solutions of the embodiments of the present application form an H-bridge structure connected by an inductor between two parallel switch control circuits. The parasitic output capacitors in the power device are charged and discharged through the inductor current. Therefore, the additional reverse switching loss caused by the excess charge in the parasitic output capacitor under light load operating conditions may be suppressed, and zero-voltage switching of the inverter under various operating conditions may be realized.

The specific embodiments of the present application have been introduced in detail above. For those skilled in the art, without departing from the principles of the present application, several improvements and modifications can be made to the present application. These improvements and modifications also fall into the scope of protection of the claims of the present application.

What is claimed is:

1. An H-bridge type parallel multi-level inverter switch module, comprising:
two switching units; and
an H-bridge inductor,
wherein:
each of the two switching units includes a first power device and a second power device connected in series,
a source of the first power device is connected to a drain of the second power device, and a connection between the source and the drain is used as a neutral point of the switching unit,
drains of the first power devices of the two switching units are connected to each other, and sources of the second power devices of the two switching units are connected to each other, and
two ends of the H-bridge inductor are respectively connected to the neutral points of the two switching units.

2. The H-bridge type parallel multi-level inverter switch module according to claim 1, wherein the first power device and the second power device are both high-level turn-on silicon carbide based power devices.

3. The H-bridge type parallel multi-level inverter switch module according to claim 2, wherein
the first power device and the second power device have a same specification;
an inductance value of the H-bridge inductor satisfies a following formula:
$$8 L \cdot {C}_{o s s} = ( 2 {T}_{s} - {T}_{d} + 3 {R}_{g} \cdot {C}_{iss} \cdot ln \frac{{V}_{g s}}{{V}_{t h}} + {R}_{g} \cdot {C}_{i s s} \cdot ln \frac{{V}_{g s}}{{V}_{g s} - {V}_{t h}} ) \times ( {T}_{d} + {R}_{g} \cdot {C}_{i s s} \cdot ln \frac{{V}_{t h}}{{V}_{g s} - {V}_{t h}} ) ,$$
where T_{g} and T_{d} are a phase shift time and a dead time of each power device respectively, V_{gs} and Vₜₕ are a gate-source voltage and a threshold voltage of each power device respectively, R_{g}, Cᵢₛₛ, and Cₒₛₛ are a gate drive resistance, an input capacitance, and an output capacitance of each power device respectively.

4. A method for optimizing an H-bridge type parallel multi-level inverter switch module, wherein:
the H-bridge type parallel multi-level inverter switch module include two switching units and an H-bridge inductor,
each of the two switching units includes a first power device and a second power device connected in series,
a source of the first power device is connected to a drain of the second power device, and a connection between the source and the drain is used as a neutral point of the switching unit,
drains of the first power devices of the two switching units are connected to each other, and sources of the second power devices of the two switching units are connected to each other, and
two ends of the H-bridge inductor are respectively connected to the neutral points of the two switching units,
the method comprises:
obtaining a switching loss of the H-bridge type parallel multi-level inverter switching module in a complete switching cycle; and
optimizing the switching loss based on a zero-voltage switching strategy under a light load operating condition, and determining an optimum inductance value for the H-bridge inductor.

5. The method for optimizing an H-bridge type parallel multi-level inverter switch module according to claim 4, wherein the switching loss includes a reverse switching loss of the first power device of each switching unit and a forward switching losses of the second power device of each switching unit.

6. The method for optimizing an H-bridge type parallel multi-level inverter switch module according to claim 5, wherein
optimizing the switching loss of the H-bridge type parallel multi-level inverter switch module in the complete switching cycle based on a zero-voltage switching strategy under a light load operating condition includes: when an inverter circuit reaches a steady state under the light load operating condition, letting the H-bridge type parallel multi-level inverter switch module satisfy the following constraints:
a first constraint in which an inductor current at the beginning of the complete switching cycle is equal to an inductor current at the end of the complete switching cycle;
a second constraint in which a voltage across the H-bridge inductor changes symmetrically within the complete switching cycle; and
a third constraint in which the reverse switching loss of the first power device of each switching unit is minimal within the complete switching cycle.

7. The method for optimizing an H-bridge type parallel multi-level inverter switch module according to claim 6, further comprising:
determining whether an output current is less than or equal to 10% of a rated operating point current; and
determining that the inverter circuit is in the light load operating condition upon determining that the output current is less than or equal to 10% of a rated operating point current.

8. The method for optimizing an H-bridge type parallel multi-level inverter switch module according to claim 6, wherein each of the first power device and the second power device includes a high-level turn-on channel, a Schottky diode, and a parasitic output capacitor.

9. The method for optimizing an H-bridge type parallel multi-level inverter switch module according to claim 8, wherein
the H-bridge type parallel multi-level inverter switch module includes four charging and discharging intervals in the complete switching cycle,
in each of the charging and discharging intervals, the H-bridge inductor is configured to charge a first parasitic output capacitor of two parasitic output capacitors of the first and second power devices of one switching unit and discharge a second parasitic output capacitor of the two parasitic output capacitors, and
the third constraint is that in each charging and discharging interval, the H-bridge inductor completely charges the first parasitic output capacitor and discharges the second parasitic output capacitor.

10. An inverter using an H-bridge type parallel multi-level inverter switch module, for converting a current output by a DC power supply into an input current of a multi-phase motor, wherein:
the H-bridge type parallel multi-level inverter switch module include two switching units and an H-bridge inductor,
each of the two switching units includes a first power device and a second power device connected in series,
a source of the first power device is connected to a drain of the second power device, and a connection between the source and the drain is used as a neutral point of the switching unit,
drains of the first power devices of the two switching units are connected to each other, and sources of the second power devices of the two switching units are connected to each other,
two ends of the H-bridge inductor are respectively connected to the neutral points of the two switching units, and
an output current of each phase is generated by at least one H-bridge type parallel multi-level inverter switch module and a corresponding cascaded coupling induction network.
